(19) United States
(12) Patent Application Publication
(10) Pub. No.: US 2023/0090761 A1
(43) Pub. Date: Mar. 23, 2023

(54) SPRING STEEL INSERT FOR A TIRE

(71) Applicant: Richard HILLERY, Tampa, FL (US)

(72) Inventor: Richard HILLERY, Tampa, FL (US)

(21) Appl. No.: 17/482,770

(22) Filed: Sep. 23, 2021

(51) Int. Cl. B60C 5/08; B60C 5/00; B60C 17/06

(52) U.S. Cl. CPC B60C 5/08; B60C 5/008; B60C 17/06; B60C 2200/12; B60C 2200/10; B60C 2200/04

(57) ABSTRACT

A tire for a vehicle includes a tire body having a circumferentially extending tread portion with an outer surface and an inner surface. First and second sidewalls are joined to the tread portion, and the first and second sidewalls terminate in first and second edges, respectively, and are configured to be secured within a flange of a rim of a wheel. In addition, the tire includes a tire insert comprising a circumferential hoop of resilient material and positioned adjacent to the inner surface of the tread portion. The tire insert may have an arcuate cross section and a width that extends across from the first sidewall to the second sidewall. The resilient material of the tire insert may comprise spring steel of a steel alloy and be in a state of compression.

### TECHNICAL FIELD

The present invention relates to the field of tires, and, more particularly, to a spring steel insert for a tire.

### BACKGROUND

Existing attempts to improve the performance of tires under different pressures are well known. For example, C-shaped springs have been described to replace the pressure provided by air in a tire to allow a tire to run without air inside. The C-shaped springs are arranged in a radial method around the tire. Although this does allow support of the vehicle while there is little or no air in the tire, a disadvantage is that the C-shaped springs do not allow the sides of the tire tread to act in a low-pressure manner.

Another example is the use of steel belts in the tires. Ordinary steel is positioned in the tire under tension to provide additional strength to the tire. A similar tire describes the use of nylon and steel belts radial tires. This is for a more durable version of the tire. A disadvantage is that these tires do not perform well at both high and low pressures.

Accordingly, what is needed in the art is a tire that has the advantages of a high-pressure tire but can also perform as a low-pressure tire.

### SUMMARY

A tire for a vehicle is disclosed. The tire includes a tire body having a circumferentially extending tread portion with an outer surface and an inner surface. First and second sidewalls are joined to the tread portion, and the first and second sidewalls terminate in first and second edges, respectively, and are configured to be secured within a flange of a rim of a wheel. In addition, the tire includes a tire insert comprising a circumferential hoop of resilient material and positioned adjacent to the inner surface of the tread portion. The tire insert may have an arcuate cross section, and the circumferential hoop may have a width that extends across from the first sidewall to the second sidewall. The resilient material of the tire insert may comprise spring steel and be in compression.

In a particular aspect, the tire may include an inner tube, where the tire insert is interposed between the inner surface of the tread portion and the inner tube. The tire insert is fixed to the inner surface of the tread portion, or at least partially integrated within the tread portion. The tread portion may comprise an elastic material and the spring steel may comprise a steel alloy. The tire is configured to be mounted to an automobile, a motorcycle, or a bicycle, for example.

In a particular aspect, a tire insert is disclosed. The tire insert is for a tire having a circumferentially extending tread portion with an outer surface and an inner surface, and first and second sidewalls joined to the tread portion, where the first and second sidewalls terminate in first and second edges, respectively, and are configured to be secured within a flange of a rim of a wheel. The tire insert includes a circumferential hoop of resilient material configured to be positioned adjacent to the inner surface of the tread portion.

In another aspect a vehicle is disclosed. The vehicle includes a vehicle body and plurality of tires mounted to the vehicle body. Each tire of the plurality of tires includes a tire body having a circumferentially extending tread portion with an outer surface and an inner surface, and first and second sidewalls joined to the tread portion. The first and second sidewalls terminate in first and second edges, respectively, and are configured to be secured within a flange of a rim of a wheel. Each tire also includes a tire insert comprising a circumferential hoop of resilient material and positioned adjacent to the inner surface of the tread portion.

### BRIEF DESCRIPTION OF THE DRAWINGS

FIG. 1 is an elevational view of a tire for a vehicle in which various aspects of the disclosure may be implemented.

FIG. 2 is a cross sectional view of the tire taken in the direction of line 2-2 of FIG. 1.

FIG. 3 is a front view of a vehicle having the tire illustrated in FIG. 1 mounted thereon.

FIG. 4 is a perspective view of a tire insert of the tire of FIG. 1.

FIG. 5 is a cross sectional view of the tire in another aspect having an inner tube.

FIG. 6 is a cross sectional view of the tire in another aspect having the tire insert partially embedded within the tire tread.

FIG. 7 is a cross sectional view of the tire in another aspect having the tire insert completely embedded within the tire tread.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The invention as explained below can be used with a standard production tire to perform as both a low-pressure tire and a high-pressure tire. Referring now to FIG. 1, a tire 102 is illustrated. The tire 102 includes a tire body 104 having a circumferentially extending tread portion 106 with an outer surface 118 and an inner surface 120. The tread portion 106 may comprise an elastic material.

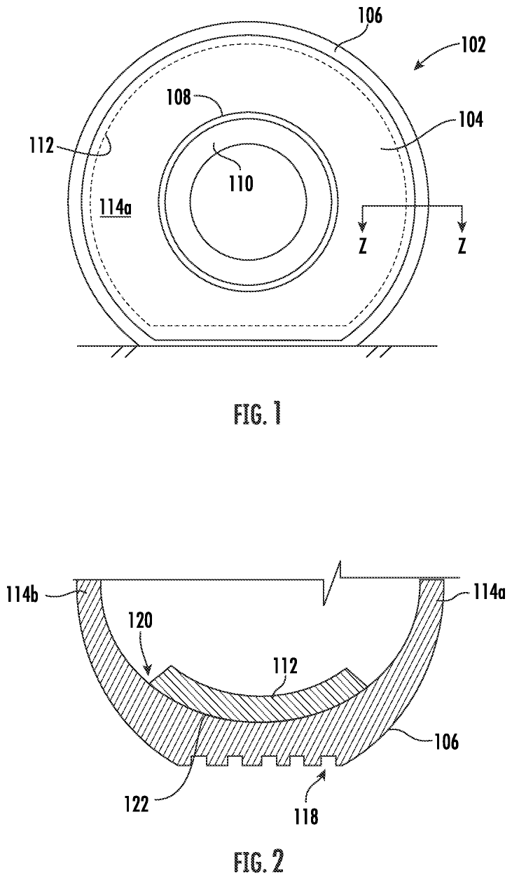

The first side of the tire 102 is illustrated in FIG. 1, where the second side is hidden from view. However, the second side of the tire is identical to the first side that is shown and the first side and second side components of the tire 102 will be referred to collectively. For example, a first sidewall 114a and a second sidewall 114b are joined to the tread portion 106 as best illustrated in FIG. 2. The first 114a and second sidewalls 114b terminate in first and second edges 108, respectively, and are configured to be secured within a flange of a rim of a wheel 110 as those of ordinary skill in the art can appreciate.

A tire insert 112 comprises a circumferential hoop. The tire insert is comprised of resilient material and is positioned adjacent to the inner surface 120 of the tread portion 106. The tire insert 112 may be fixed to the inner surface 120 of the tread portion 118 using an adhesive 122 or other similar fastener as those of ordinary skill in the art can appreciate.

As illustrated in FIG. 2, the tire insert 112 is shown within a relatively narrow tire 102. If the tire is wider, the tire insert 112 can be the same width, or smaller and thicker. The amount of the tread outside of the tire insert 112 will not have that support, and the tire 102 at that point will act similar to a low-pressure tire.

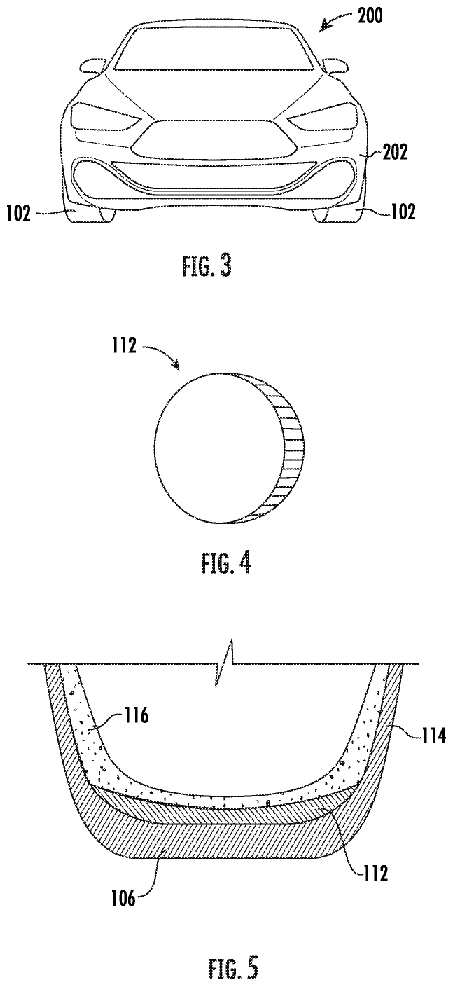

In a particular aspect, a vehicle 200 may have the tire 102 (or a plurality of tires 102) mounted to a vehicle body 202 as illustrated in FIG. 3. While an automobile is shown, the tire 102 may be used with a truck, motorcycle, bicycle or any other vehicle as those of ordinary skill in the art can appreciate. For example, the gas mileage typically suffers on hard surfaces when vehicles are equipped with large soft tires for off-road use. Accordingly, the tire insert 112 is most useful on dual use vehicles, such as off-road truck and SUVs, as well as dual use motorcycles. The tire insert 112 allows better gas mileage on off-road tires when used on the road because only the tread portion 106 under the tire insert 112 will be at a high-pressure contact while keeping the low-pressure advantages for off-road use.

In particular, the spring steel of the tire insert 112 provides support similar to that of a high-pressure pneumatic support, but without the high pressure. The tire sidewalls 114a, 114b with the tire insert 112 act similar to radial spokes on a rim and provide support to the weight of the vehicle with a low to high pressure of air inside a tire. The characteristics of the spring steel provides flexibility and durability to the tire 102 while still supporting most of the vehicle weight on a hard surface.

The spring steel does not significantly enhance support to the sides of the treads or on the sidewalls but instead allows the low-pressure inside the tire to provide support on soft surfaces. The tire insert 112 combined with the tread portion 106 and sidewalls 114a, 114b places the spring steel under compression, not tension.

The compression of the tire insert 112 being a spring steel hoop will support the vehicle body 202 with little to no air under low performance conditions. It will be able to keep the tire 102 on the rim 110 as the flat tire will not bottom out except under high performance stress, allowing the edge 108 to stay connected to the rim 110 with little to no tire pressure and having limited run flat capability.

In a particular aspect the tire insert 112 is illustrated in FIG. 4 having an arcuate cross section that provides additional strength but, alternatively, may have a flat cross section in another aspect. Accordingly, the cross section of the tire insert 112 is not limited to an arcuate shape and may have one of a plurality of different cross sectional shapes, including flat, or with beams and a flat bottom.

The circumferential hoop (i.e. tire insert 112) comprises a width that extends across from the first sidewall 114a to the second sidewall 114b. The resilient material of the tire insert 112 comprises spring steel in a particular aspect and the tire insert 112 is in a state of compression. The tire insert 112 is not required to conform to the shape of the tire in a particular aspect. For example, the cross sectional shape of the tire insert 112 may be an extra 41 inch deeper in the center in order to have a reduced area for increased gas mileage, but will respond with as little as 4 inch of deflection. As those of ordinary skill in the art can appreciate, the shape of the cross section of the tire insert 112 depends in part on the desired characteristics of the tire 102.

The tire insert 112 is intended to be used for a tire having enough air pressure to keep the tire body 104 mounted on the rim 110 and to provide support to the vehicle on the ground. The tire insert 112 comprises a single circumferential spring steel hoop that provides additional support of a less flexible manner than the pneumatic support provided by the air pressure inside the tire 102.

As explained above, the tire insert 112 is preferably used with dual use type of tires. This is because the low pressure of the air combined with the stiffness of the spring steel of the tire insert 112 results in a tire 102 that performs as a high-pressure tire on hard surfaces, and performs as a low-pressure tire on soft surfaces. The advantage of a high-pressure tire is that it has a very low rolling resistance, providing ease of pedaling for bicycles and better gas mileage for vehicles such as cars and trucks. The advantage of a low-pressure tire is that it does not bog down in soft terrain. The spring steel of the tire insert 112 included with the tire tread portion 106 results in an improved tire that performs well in multiple road conditions.

In addition, the configuration and shape of the tire insert 112 reinforces the tread portion 106 to make the tread stronger. A purpose of the tire insert 112 is to provide strength to the tread portion 106 that would normally be provided with high-pressure inside the tire or tube. Instead, the sidewalls 114a, 114b of the tire 102 act as spokes in a wheel to support the tire insert 112 when the tire 102 is at low pressure.

In a particular aspect, the tire insert 112 is one piece that is configured circumferentially, not radially or axially. A radial configuration is when the reinforcement is positioned from side to side under the tread portion, and a radial configuration refers to the reinforcement running up and down the tire sidewalls. The tire insert 112 described herein has a similar curvature to a top of an inner tube and is rigid.

The use of spring steel of the tire insert 112 instead of normal steel is preferred because the spring steel is used in compression to provide support of the tread portion 106, as opposed to the normal use of steel, Kevlar, or similar material under tension. Regular steel will fatigue if it is flexed multiple times, and in addition it is not resilient and does not spring back to its regular shape.

Referring now to FIG. 5, in a particular aspect the tire 102 includes an inner tube 116 rather than being tubeless. The tire insert 112 is interposed between the inner surface 120 of the tread portion 106 and the inner tube 116.

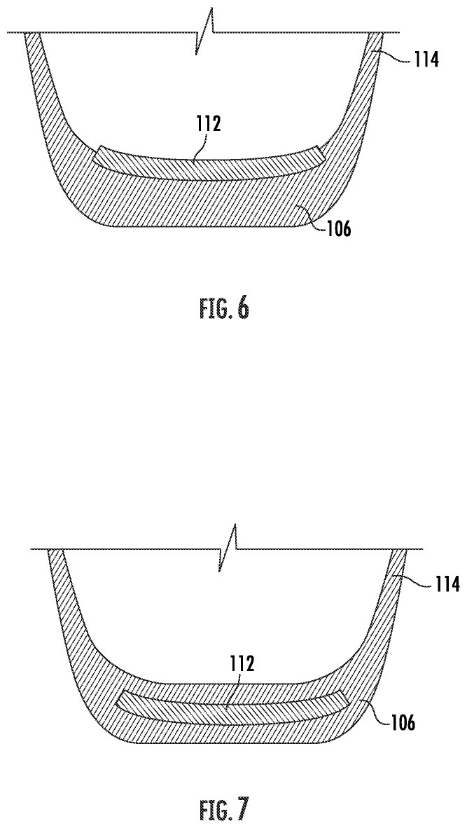

Referring now to FIGS. 6 and 7, the tire insert 112 is partially integrated and embedded within the tread portion 106 as illustrated in FIG. 6. The tire insert 112 can also be completely embedded within the tread portion 106 as illustrated in FIG. 7.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A tire for a vehicle, the tire comprising:
a tire body having a circumferentially extending tread portion with an outer surface and an inner surface, and first and second sidewalls joined to the tread portion, the first and second sidewalls terminating in first and second edges, respectively, and configured to be secured within a flange of a rim of a wheel; and
a tire insert comprising a circumferential hoop of resilient material and positioned adjacent to the inner surface of the tread portion.

2. The tire of claim 1, wherein the tire insert has an arcuate cross section.

3. The tire of claim 1, wherein the circumferential hoop comprises a width that extends across from the first sidewall to the second sidewall.

4. The tire of claim 1, wherein the resilient material comprises spring steel.

5. The tire of claim 1, further comprising an inner tube, the tire insert interposed between the inner surface of the tread portion and the inner tube.

6. The tire of claim 1, wherein the tire insert is in a state of compression.

7. The tire of claim 1, wherein the tire insert is fixed to the inner surface of the tread portion.

8. The tire of claim 1, wherein the tire insert is at least partially integrated within the tread portion.

9. The tire of claim 1, wherein the tread portion comprises an elastic material.

10. The tire of claim 1, wherein the spring steel comprises a steel alloy.

11. The tire of claim 1, wherein the tire is configured to be mounted to an automobile.

12. The tire of claim 1, wherein the tire is configured to be mounted to a motorcycle.

13. The tire of claim 1, wherein the tire is configured to be mounted to a bicycle.

14. A tire insert for a tire having a circumferentially extending tread portion with an outer surface and an inner surface, and first and second sidewalls joined to the tread portion, the first and second sidewalls terminating in first and second edges, respectively, and configured to be secured within a flange of a rim of a wheel, the tire insert comprising:
a circumferential hoop of resilient material and configured to be positioned adjacent to the inner surface of the tread portion.

15. The tire insert of claim 14, wherein the tire insert has an arcuate cross section.

16. The tire insert of claim 1, wherein the resilient material comprises spring steel.

17. The tire insert of claim 1, wherein the tire insert is in a state of compression.

18. The tire insert of claim 1, wherein the spring steel comprises a steel alloy.

19. A vehicle comprising:
a vehicle body;
a plurality of tires mounted to the vehicle body, wherein each tire of the plurality of tires comprising,
a tire body having a circumferentially extending tread portion with an outer surface and an inner surface, and first and second sidewalls joined to the tread portion, the first and second sidewalls terminating in first and second edges, respectively, and configured to be secured within a flange of a rim of a wheel; and
a tire insert comprising a circumferential hoop of resilient material and positioned adjacent to the inner surface of the tread portion.

20. The vehicle of claim 19, wherein the resilient material comprises spring steel.
